(19) United States
(12) Patent Application Publication
(10) Pub. No.: US 2014/0252196 A1
(43) Pub. Date: Sep. 11, 2014

(54) Music Stand and Rack, Pedestal and Hinge Therefor

(71) Applicant: Jason Abady, Glen Allen, VA (US)

(72) Inventor: Jason Abady, Glen Allen, VA (US)

(21) Appl. No.: 13/794,116

(22) Filed: Mar. 11, 2013

(51) Int. Cl. A47B 19/00; E05D 7/00

(52) U.S. Cl. CPC A47B 19/002; E05D 7/00
USPC 248/447; 248/441.1; 248/460; 248/463; 248/464; 16/221

(57) ABSTRACT

Disclosed is a music stand that includes a column with a first segment having at least one positional slot and a second segment having a protrusion configured to be received in each of the positional slots. When the protrusion is received in one of the positional slots, the protrusion can prevent relative translation of the first segment and the second segment in at least one direction, thereby defining a unique extension. The music stand also includes a support selected from a rack and a pedestal that is fixed relative to said column.

### BACKGROUND OF THE INVENTION

The present invention relates to stands for supporting sheet music during musical performances and practices, and more particularly to stands that are readily disassembleable and collapsible for storage and transport thereof between uses.

Music stands typically include a planar rack or backing, and a shelf or ledge along one edge of and generally perpendicular to the rack. The rack is supported by a column that extends from a pedestal, typically having collapsible legs. The column/rack coupling typically is adjustable to support the rack at an incline from horizontal. This arrangement maintains sheet music against the rack with the bottom edge thereof supported by the shelf. While this type of stand most frequently is used by musicians, it also can be used during presentations to support books, sheets of paper and other materials.

One popular music stand features an open-frame construction in which the rack, column and pedestal are combined in a single, collapsible framework. These stands, while useful in certain circumstances, tend to be unstable, particularly when required to support heavier books or multiple sheets of music.

Another disadvantage of these light-weight, open-frame stands is that they tend to damage easily. Since these stands tend to be integrally-constructed, repair often must be effected by complete replacement.

Non-collapsible music stands, while more stable, are difficult to transport and store.

What is needed and not taught or suggested in the art is a music stand that is disassembleable and collapsible for storage and transport, yet robust and stable for supporting heavy items and long-term usage.

### SUMMARY OF THE INVENTION

The invention overcomes the disadvantages noted above by providing a music stand that is disassembleable and collapsible for storage and transport, yet robust and stable for supporting heavy items and long-term usage.

To that end, an embodiment of a music stand configured according to principles of the invention includes a column with a first segment having at least one positional slot and a second segment having a protrusion configured to be received in each of the positional slots. When the protrusion is received in one of the positional slots, the protrusion can prevent relative translation of the first segment and the second segment in at least one direction, thereby defining a unique extension. The music stand also includes a support selected from a rack and a pedestal that is fixed relative to the column.

The invention provides improved elements and arrangements thereof, for the purposes described, which are inexpensive, dependable and effective in accomplishing intended purposes of the invention.

Other features and advantages of the invention will become apparent from the following description of the preferred embodiments, which refers to the accompanying drawings.

### BRIEF DESCRIPTION OF THE DRAWINGS

The invention is described in detail below with reference to the following figures, throughout which similar reference characters denote corresponding features consistently, wherein:

FIG. 1 is a right, front elevational view of an embodiment of a music stand configured according to principles of the invention in an open position;

FIG. 2 is a right side elevational view of the embodiment of FIG. 1 in a closed position;

FIG. 3 is an exploded perspective view of the column and pedestal of the embodiment of FIG. 1;

FIG. 4 is a perspective view of the embodiment of FIG. 3;

FIG. 5 is an exploded perspective view of the upper extension and hinge of the embodiment of FIG. 1;

FIGS. 6a and 6b are cross-sectional detail views respectively of the upper extension and middle extension of another embodiment of a music stand configured according to principles of the invention;

FIGS. 7a and 7b respectively are cross-sectional detail and partial inside elevational views of the upper extension of another embodiment of a music stand configured according to principles of the invention;

FIGS. 8a and 8b respectively are cross-sectional detail and partial inside elevational views of the middle extension of the embodiment of FIG. 7;

FIG. 9 is a partial cross-sectional detail view, drawn along lines IX-IX, in FIGS. 7 and 8;

FIGS. 10a and 10b respectively are cross-sectional detail and partial inside elevational views of the upper extension of another embodiment of a music stand configured according to principles of the invention;

FIGS. 11a and 11b respectively are cross-sectional detail and partial inside elevational views of the middle extension of the embodiment of FIG. 10;

FIG. 12 is a top, front, right elevational view of the rack of the embodiment of FIG. 1;

FIG. 13 is a cross-sectional detail view drawn along line XIII-XIII in FIG. 12;

FIG. 14 is a front elevational view of the embodiment of FIG. 12;

FIG. 15 is a top, right, rear elevational view of a hinge of the embodiment of FIG. 1;

FIG. 16 is a top, left, front elevational view of the bracket of the embodiment of FIG. 1;

FIG. 17 is a top, left, front elevational view of a cap of the embodiment of FIG. 1;

FIG. 18 is a side elevational view of the pedestal of the embodiment of FIG. 1;

FIGS. 19 and 20 are side, bottom elevational views, respectively exploded and assembled, of the pedestal, lower extension and structure for collapsing the pedestal relative to the lower extension of the embodiment of FIG. 1;

FIG. 21 is a partial side elevational view of the pedestal and column of the embodiment of FIG. 1;

FIG. 22 is a top, left, front elevational view of another embodiment of a music stand configured according to principles of the invention in an open position;

FIG. 23 is a right side elevational view of the embodiment of FIG. 22 in a closed position;

FIG. 24 is an exploded, bottom, side elevational view of the pedestal, lower extension and another structure for collapsing the pedestal relative to the lower extension;

FIG. 25 is a partial bottom, side elevational view of the pedestal of FIG. 24;

FIG. 26 is a bottom, side elevational view of the base for the pedestal of FIG. 24;

FIG. 27 is a partial bottom, side elevational view of another embodiment of a pedestal configured according to principles of the invention;

FIG. 28 is a partial bottom, side elevational view of another embodiment of a pedestal configured according to principles of the invention;

FIG. 29 is a top, side elevational view of another embodiment of a hinge configured according to principles of the invention; and

FIG. 30 is a top, right, rear elevational view of another embodiment of a hinge configured according to principles of he invention.

### DETAILED DESCRIPTION OF THE PREFERRED EMBODIMENTS

The invention is a music stand that is disassembleable and collapsible for storage and transport, yet robust and stable for supporting heavy items and long-term usage.

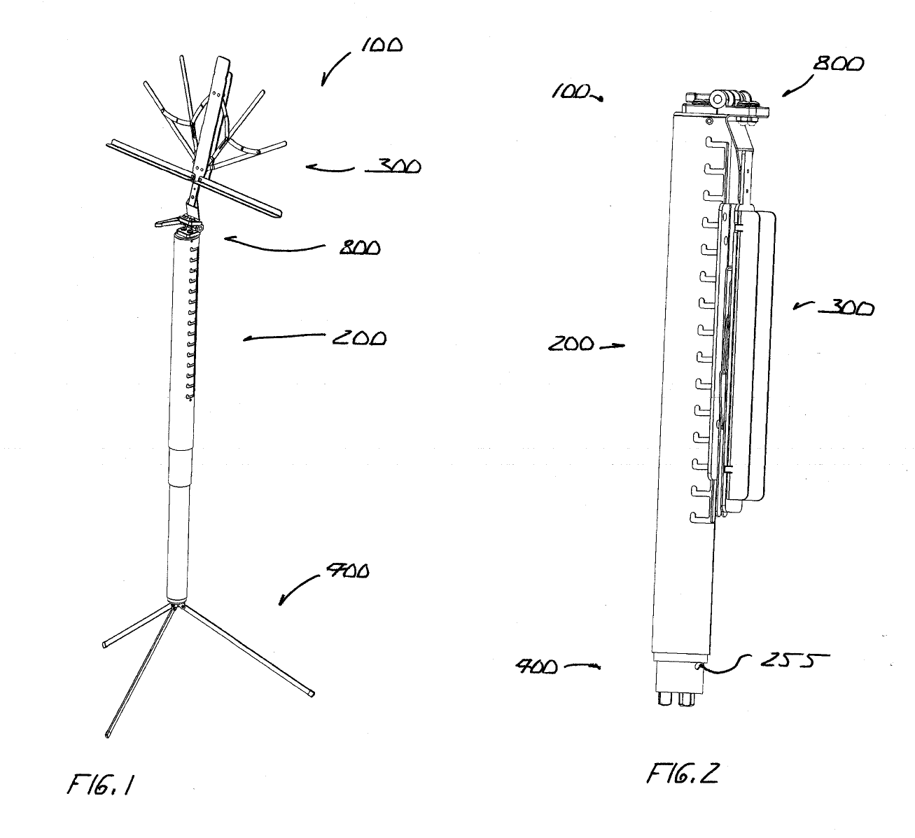

Referring to FIG. 1, an embodiment of a music stand 100 configured according to principals of the invention includes three basic components: a column 200; a rack 300; and a pedestal 400. These basic components are intended to be detachable, hence replaceable.

Referring to FIG. 2, music stand 100 is configured to collapse into a collapsed or closed position, as shown.

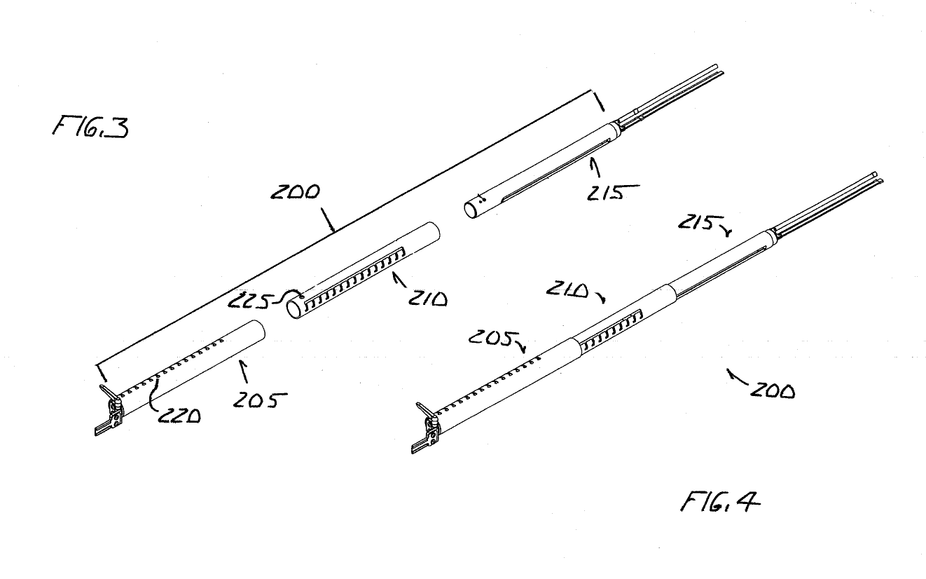

Referring to FIGS. 3 and 4, column 200 includes three sections: an upper extension 205; a middle extension 210; and a lower extension 215. Upper extension 205 telescopingly receives middle extension 210, and middle extension 210 telescopingly receives lower extension 215, thereby providing for extensibility, as shown in FIG. 4.

Upper extension 205 and middle extension 210 can be fixed relatively with means for locking described herein, or other appropriate means. Middle extension 210 and lower extension 215 also can be fixed relatively with similar or comparable means for locking.

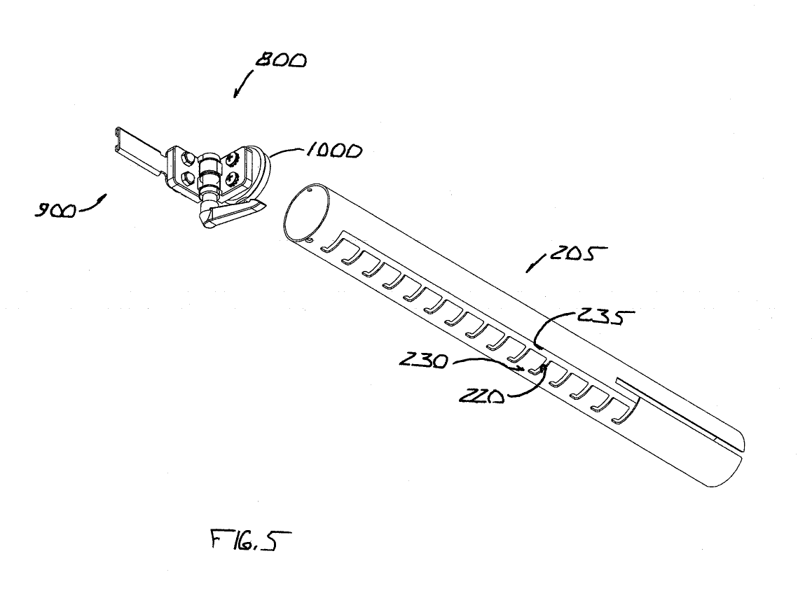

One example of means for locking, shown with respect to upper extension 205 and middle extension 210, employs axially-arranged transverse positional slots 220 in upper extension 205, which are configured to receive a protrusion 225 that extends from middle extension 210. Referring also to FIG. 5, each positional slot 220 terminates in a detent 230, which discourages protrusion 225 from inadvertently slipping out of positional slot 220 and into transitional slot 235. Detent 230 also discourages rotation of the components of music stand 100 while in use, such as while turning sheets of music on rack 300. Positional slots 220 are interconnected with a transitional slot 235 through which protrusion 225 may translate for adjusting the relative positioning of upper extension 205 and middle extension 210, hence the height of rack 300 relative to pedestal 400.

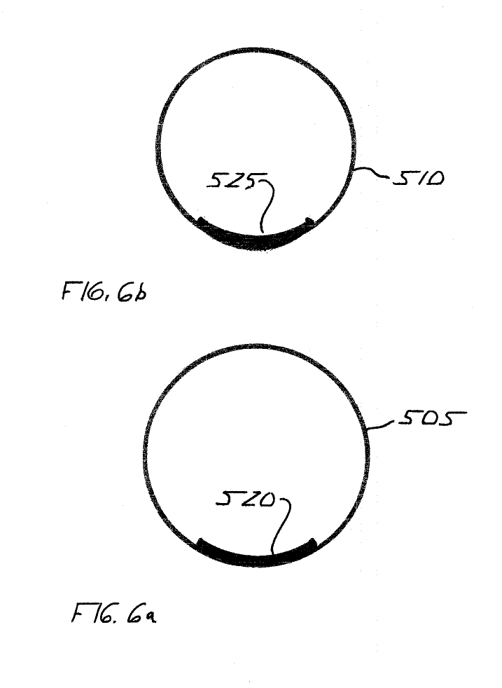

Referring to FIG. 6, another example of means for locking involves attractive, preferably magnetic principles for securing one extension relative to another. In this embodiment, upper extension 505 is comparable to upper extension 205, except that, rather than positional slots 220, upper extension 505 includes a strip of material 520 running along the inside length thereof. Middle extension 510 is comparable to middle extension 210, except that, rather than a protrusion 225, middle extension 510 includes a strip of material 525 running along the outside length thereof.

Material 520 and material 525 are mutually attractive, preferably magnetically attractive. Material 520 and material 525 also are configured so that when upper extension 505 and middle extension 510 are rotated relatively about their common axis, material 520 and material 525 may be positioned so that, in one position, no attraction exists, thereby allowing upper extension 505 to translate axially relative to middle extension 510, and in another position, attraction persists, thereby preventing upper extension 505 from translating axially relative to middle extension 510.

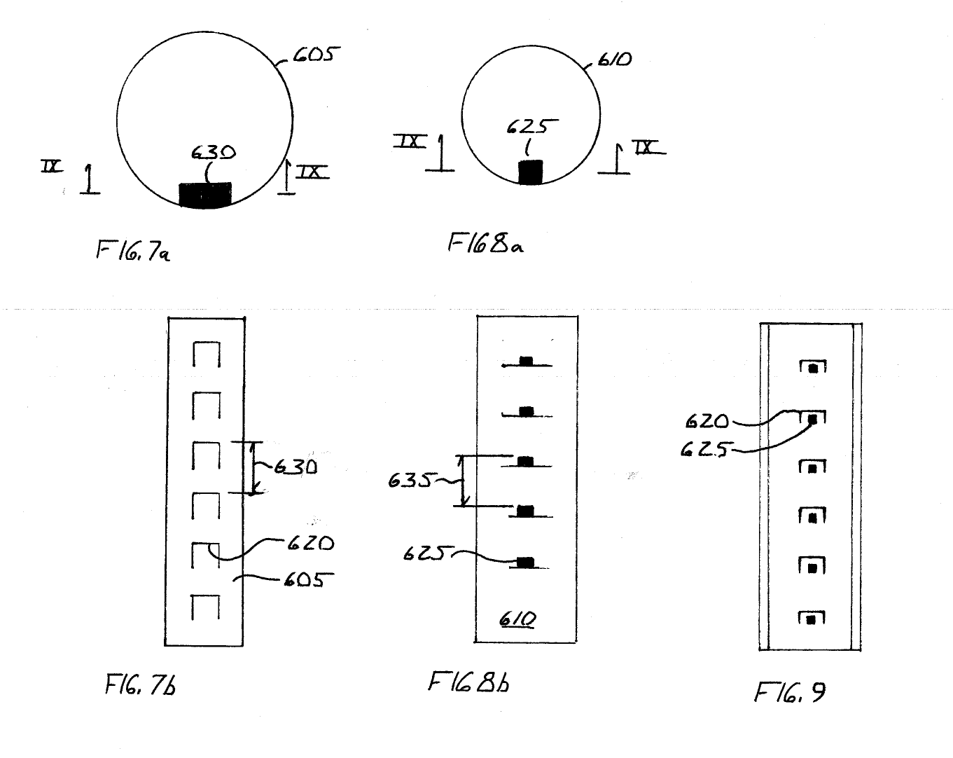

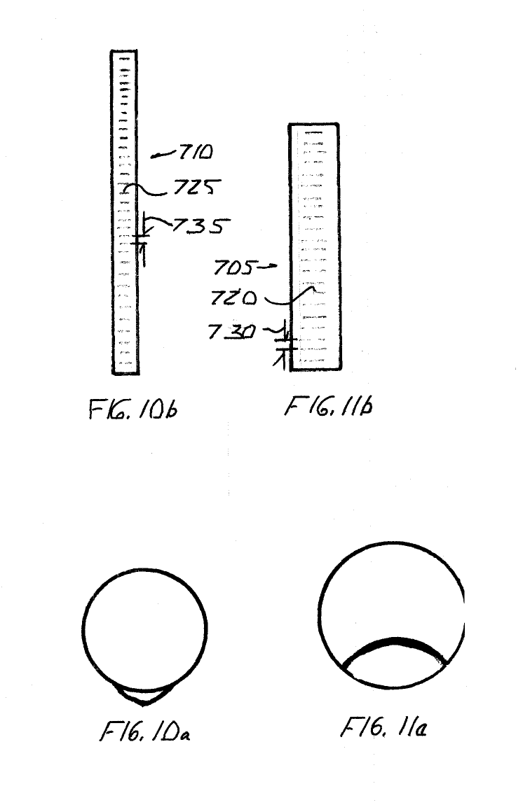

Referring to FIGS. 7-9, another example of means for locking involves complementary notch-and-pocket structures. In this embodiment, upper extension 605 is comparable to upper extension 205, except that, rather than positional slots 220, upper extension 605 includes one or more axially-arranged pockets 620 along the inside length thereof. Middle extension 610 is comparable to middle extension 210, except that, rather than a protrusion 225, middle extension 610 includes one or more axially-arranged notches 625 along the outside length thereof.

Preferably, pockets 620 and notches 625 are configured and aligned respectively with upper extension 605 and middle extension 610 so that, upper extension 605 and middle extension 610 may be rotated about their common axis into one position so that upper extension 605 and middle extension 610 may be translated axially, and into another position so that pockets 620 restrict movement of notches 625, thereby restricting axial translation of upper extension 605 and middle extension 610, in at least one direction.

A variation of this embodiment employs multiple pockets 620 and notches 625, wherein a spacing 630 between each of pockets 620 corresponds to a spacing 635 between each of notches 625. When in registry, each of notches 625 is received in each of pockets 620, as shown in FIG. 9.

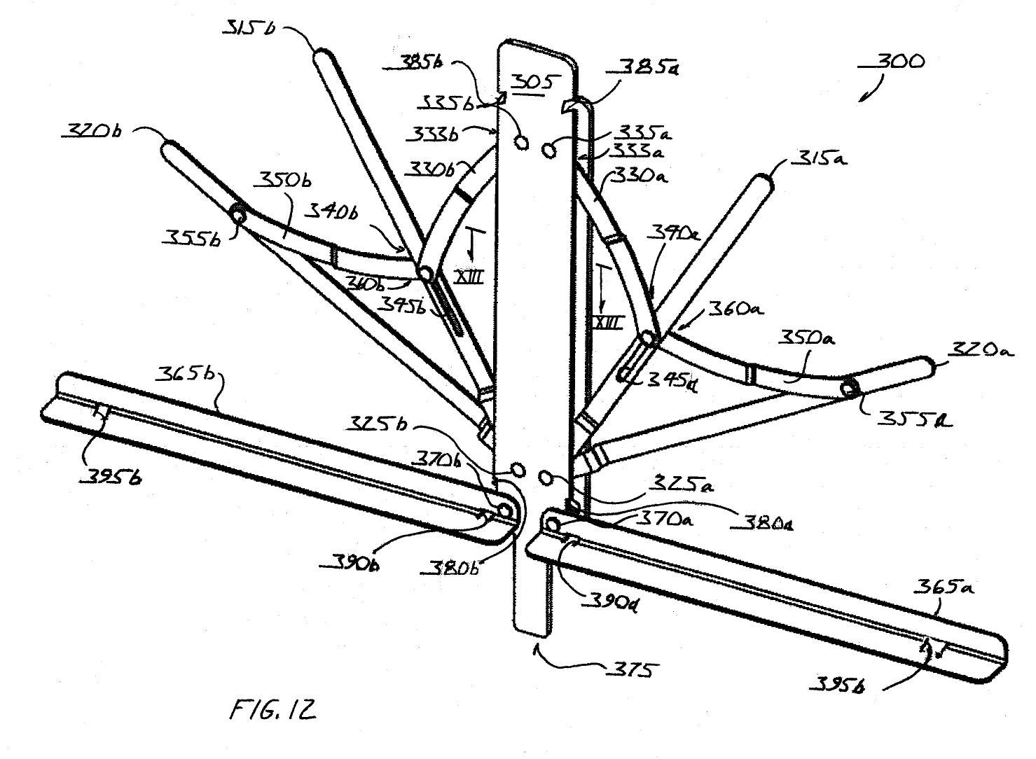

Referring to FIGS. 10 and 11, another example of means for locking involves interlocking, opposed notches. In this embodiment, upper extension 705 is comparable to upper extension 205, except that, rather than positional slots 220, upper extension 705 includes notches 720 formed by punching discrete sections of material radially inwardly. Middle extension 710 is comparable to middle extension 210, except that, rather than a protrusion 225, middle extension 710 includes notches 725 formed by punching discrete sections of material radially outwardly.

Preferably, notches 720 and notches 725 are configured and aligned respectively along upper extension 705 and middle extension 710 so that, upper extension 705 and middle extension 710 may be rotated about their common axis into one position so that upper extension 705 and middle extension 710 may translate axially, and into another position so that notches 720 restrict movement of notches 725, thereby restricting relative axial translation of upper extension 705 and middle extension 710 in at least one direction.

A variation of this embodiment employs multiple notches 720 and notches 725, wherein a spacing 730 between each of notch 720 corresponds to a spacing 735 between each of notches 725. When in registry, each of notches 720 at least rests on a corresponding notch 725, as shown in FIG. 9.

Another variation of this embodiment provides for spacing 730 corresponding to a vertical height (not shown) of notch 725. When brought into registry with notches 720, an adjacent pair of notches 720 captures a notch 725. Spacing 735 also may be coordinated with respect to a vertical height (not shown) of notch 720.

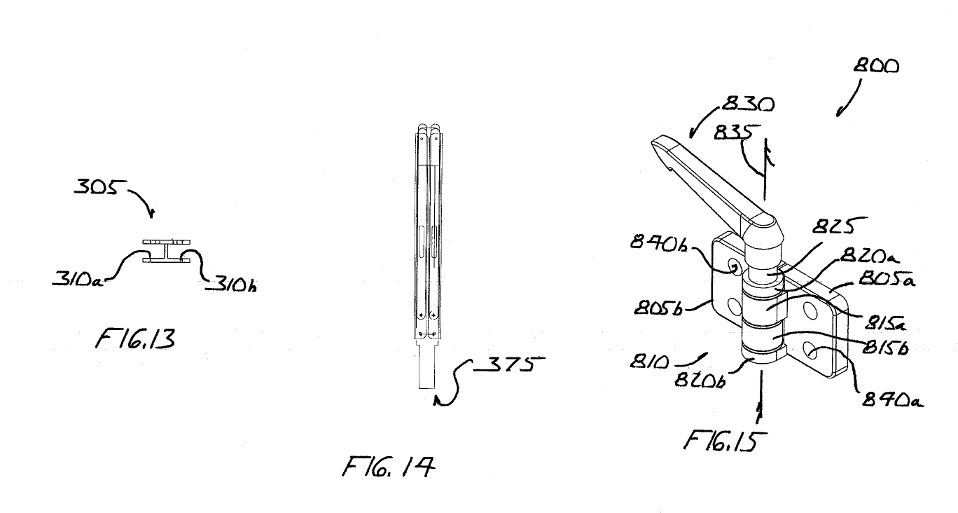

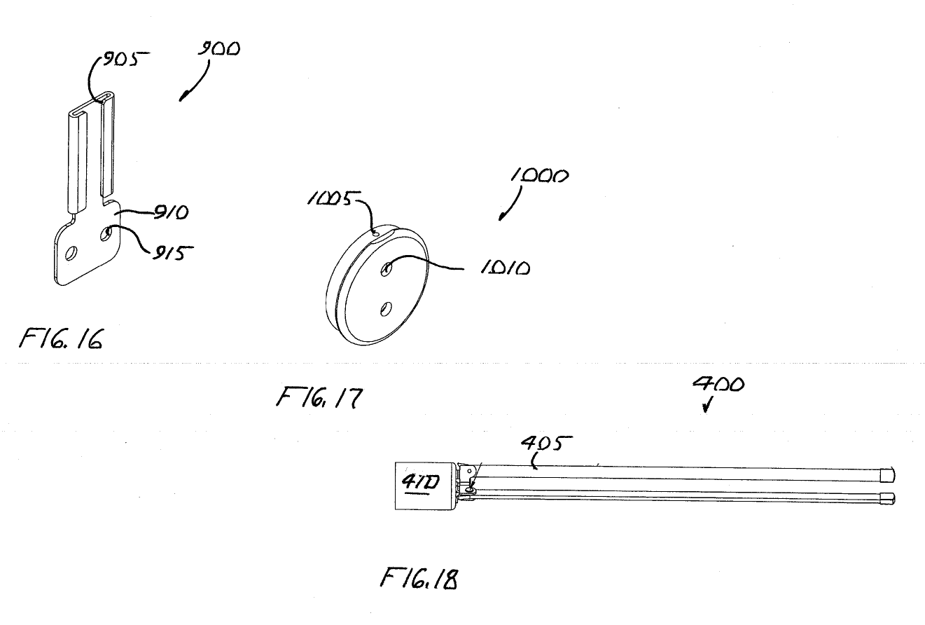

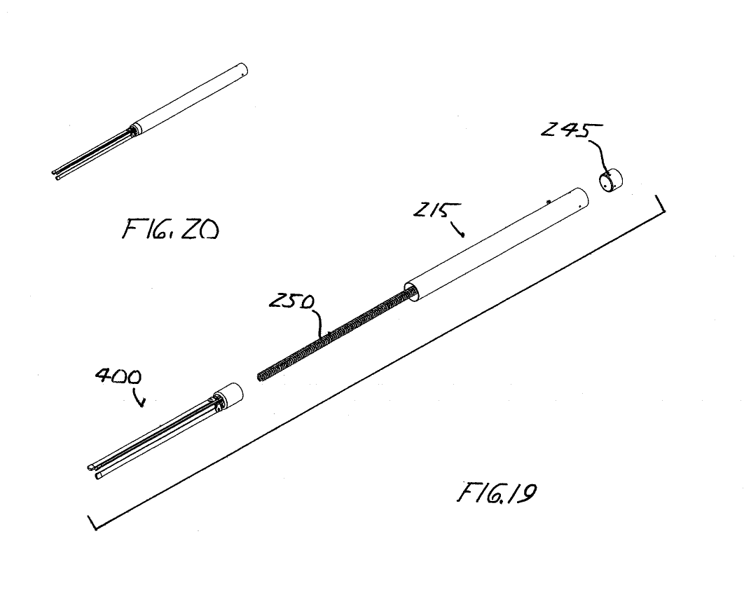

Referring to FIGS. 12-14, rack 300 includes a frame 305 that defines symmetrical channels 310a, 310b. Arms 315a, 315b and 320a, 320b are mounted on frame 305 so that they may pivot about point 325a, 325b from an open position, as shown in FIG. 12, through to a closed position, as shown in FIG. 14. Preferably, when in the closed position, arms 315a, 315b and 320a, 320b are received in respective channels 310a, 310b.

A link 330a, 330b has one end 333a, 333b that is mounted on frame 305 so that it may pivot about point 335a, 335a, for example by means of a rivet. Link 330a, 330b has a second end 340a, 340b that is connected to arm 315a, 315b so that it may translate freely relative to a slot 345a, 345b in arm 315a, 315a, for example by means of a rivet. Link 330a, 330b and slot 345a, 345b are configured to prevent arm 315a, 315b from articulating beyond the open position shown in FIG. 12, and attain the closed position shown in FIG. 14.

A link 350a, 350b has one end 355a, 355b that is mounted on arm 320a, 320b so that it may pivot about point 355a, 355a, for example by means of a rivet. Link 350a, 350b has a second end 360a, 360b connected to arm 315a, 315a, for example by means of a rivet, so that it may translate freely relative to slot 345a, 345b in arm 315a, 315a, for example by means of a rivet. Link 350a, 350b and slot 345a, 345b are configured to prevent arm 320a, 320b from articulating beyond the open position shown in FIG. 12, and attain the closed position shown in FIG. 14.

Preferably, when in the closed position, links 330a, 330b and 350a, 350b are received in respective channels 310a, 310b.

Rack 300 also includes symmetrically arranged shelves 365a, 365b pivotally mounted on frame 305 so that they may pivot about a point 370a, 370b, for example by means of a rivet, from an open position, as shown in FIG. 12, through to a closed position, as shown in FIG. 14.

Frame 305 may have notches 380a, 380b and 385a, 385a, and shelves 365a, 365b may have corresponding notches or protrusions 390a, 390b and 395a, 395b. When rack 300 defines a closed position, as shown in FIG. 23, notches or protrusions 390a, 390b and 395a, 395b are received respectively in notches 380a, 380b and 385a, 385b.

While not shown, the invention includes an embodiment where shelf 365a, 365a, when defining the closed position, is received within respective channel 310a, 310b.

While also not shown, the invention also includes an embodiment with a link (not shown) comparable to links 330a, 330b and 350a, 350b, whereby articulation of shelf 365a, 365b is limited relative to frame 305, arm 315a, 315b and/or arm 320a, 320b.

Also not shown, but within the scope of the invention, is an embodiment whereby articulating arm 315a, 315b and/or 320a, 320b on one side of frame 305 correspondingly articulates the other arm 315a, 315b and/or 320a, 320b on the symmetrically opposite side of frame 305.

Yet another unillustrated, but contemplated embodiment of the invention provides for synchronized deployment of shelves 365a, 365b with or without simultaneous deployment of link-connected arms 315a, 315b or 320a, 320b.

Frame 305 has a tang 375 configured to be received in a bracket 800, described below.

Referring to FIGS. 1, 2 and 15, preferably, rack 300 and column 200 preferably are connected with a hinge 800. Hinge 800 has wings 805a, 805b symmetrically disposed about a knuckle 810. Knuckle 810 is composed of interlocking hubs 815a, 815b and 820a, 820b connected to a respective wing 805a, 805b. A threaded pin 825, having a lever 830 at a proximal end is received a through all of hubs 815a, 815b and 820a, 820b. Pin 825 threadingly engages at least one of the more distally-located hubs 815a, 815b and/or 820a, 820b so that turning lever 830 about the axis 835 of knuckle 810 in one direction causes one or more of hubs 815a, 815b and 820a, 820b to squeeze together, thereby discouraging relative movement of wings 805a, 805a, and turning lever 830 about the axis 835 in the opposite direction releases compression among hubs 815a, 815b and 820a, 820b, thereby permitting relative movement of wings 805a, 805b.

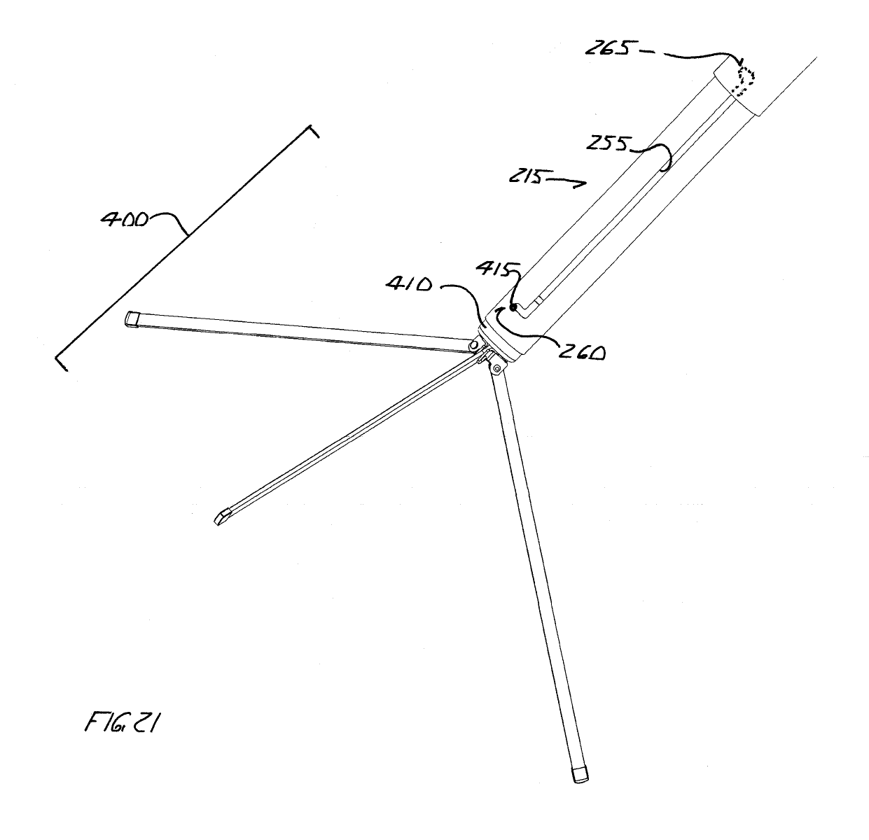

Referring also to FIG. 16, rack 300 and hinge 800 preferably are connected with a bracket 900. Bracket 900 defines an open channel 905 that is configured too closely receive tang 375 of rack 300. Plate 910 is configured to be mounted on one of wings 805a, 805b of hinge 800, for example by bringing into registry throughbores 915 with either set of throughbores 840a, 840b of respective wing 805a, 805b.

Referring to FIGS. 5, 15 and 17, column 200 and hinge 800 preferably are connected with a cap 1000. Cap 1000 may have throughbores 1005 that may be brought into registry with throughbores 240 in the upper extension 205, as shown in FIG. 5, through which appropriate fasteners (not shown) may be inserted. Cap 1000 also may have throughbores 1010 that may be brought into registry with the other set of throughbores 840a, 840b of respective wing 805a, 805b.

Referring to FIG. 30, another embodiment of a hinge 1700 configured according to principles of the invention has wings 1705 and 1707 disposed about a knuckle 1710. Knuckle 1710 is composed of interlocking hubs 1715a, 1715b and 1720a, 1720b connected to a respective wings 1705, 1707. A threaded pin 1725, having a knob 1730 at a proximal end is received a through all of hubs 1715a, 1715a, and 1720a, 1720b. Pin 1725 threadingly engages at least one of the more distally-located hubs 1715a, 1715b and/or 1720a, 1720b so that turning lever 1730 about the axis 1735 of knuckle 1710 in one direction causes one or more of hubs 1715a, 1715b and 1720a, 1720b to squeeze together, thereby discouraging relative movement of wings 1705, 1707, and turning lever 1730 about the axis 1735 in the opposite direction releases compression among hubs 1715a, 1715b and 1720a, 1720b, thereby permitting relative movement of wings 1705, 1707.

When substituting hinge 1700 for hinge 800, wing 1705 has throughbores 1740a, 1740b that may be brought into registry with throughbores 915 of bracket 900. Wing 1707 has a boss 1745 that may be received in an upper end of upper extension 205 and secured thereto by staking or removeable fasteners comparable to other staked elements of the invention described herein.

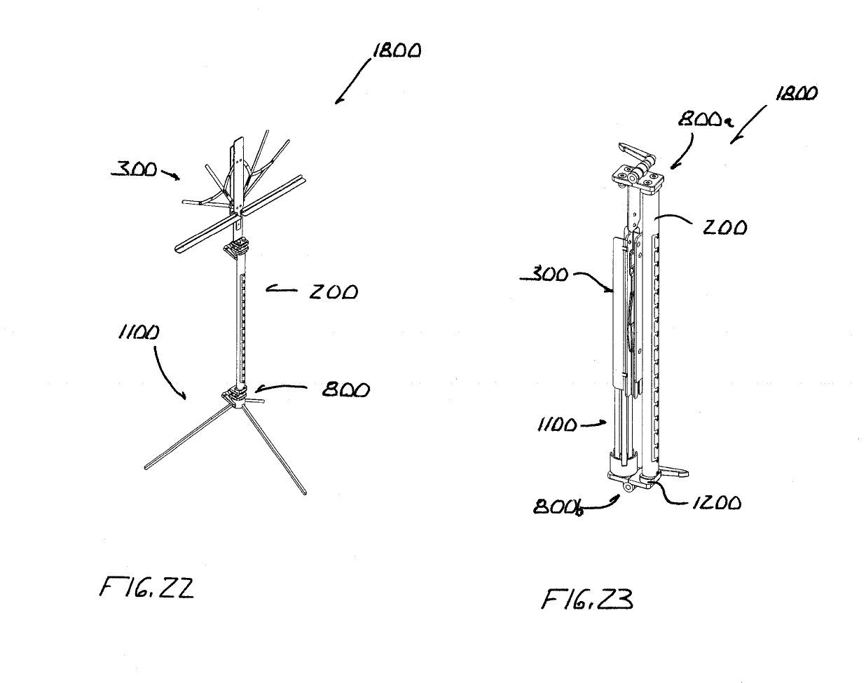

Referring again to FIGS. 1 and 2 and also FIG. 18, pedestal 400 preferably includes a number of legs 405 that are pivotally mounted on a base 410. Each of legs 405 may articulate from a closed position, as shown in FIG. 18, through and to an open position, as shown in FIG. 1.

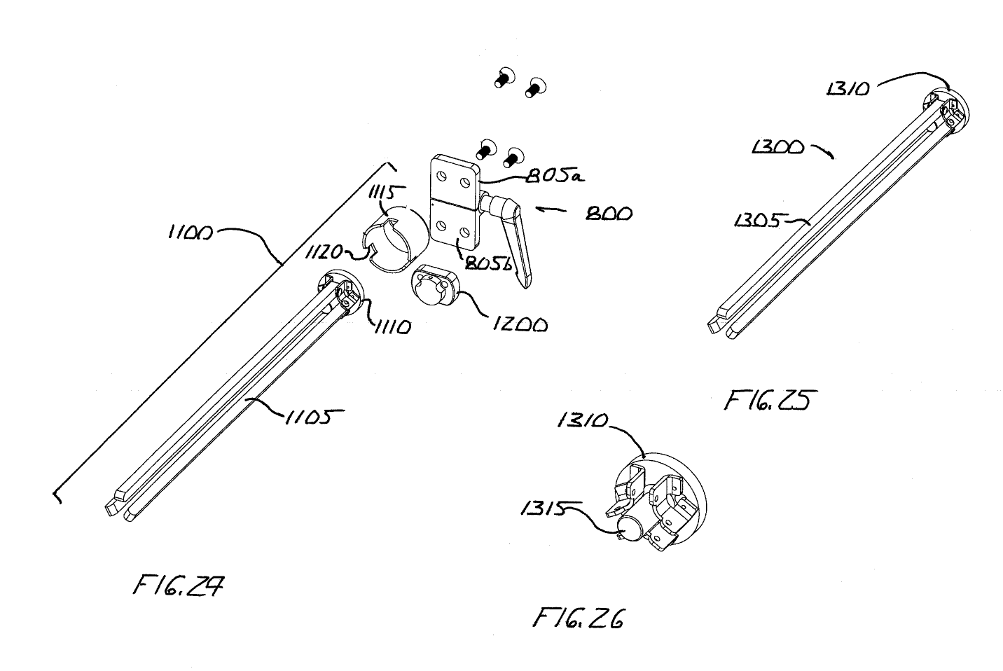

Referring also to FIGS. 2, 19 and 20, pedestal 400 preferably is configured to be stowed within lower extension 215. A cap 245 is configured, like cap 1000, so that it may be secured or staked to an upper end of lower extension 215. A compression spring 250 is received within lower extension 215 and abuts cap 245. Pedestal 400 is loaded, base 410 first, into the lower end of lower extension 215 against spring 250, as shown in FIG. 20. Pedestal 400 may be driven into lower extension 215 and eventually define a stowed position, as shown in FIG. 2. Spring 250 biases pedestal 400 outwardly from lower extension 215.

Referring to FIG. 21, cap 410 preferably includes a protrusion 415 that is received in an axially-aligned slot 255 in lower extension 215. Slot 255 preferably has a detent 260 near the lower end of lower extension 215 and a detent 265 at an upper end of lower extension 215. When protrusion 415 is received in detent 260, pedestal 400 is discouraged from traversing axially within lower extension 215. When protrusion 415 is received in detent 265, pedestal 400 also is discouraged from traversing axially within lower extension 215 and is stowed and secured against the bias of spring 250.

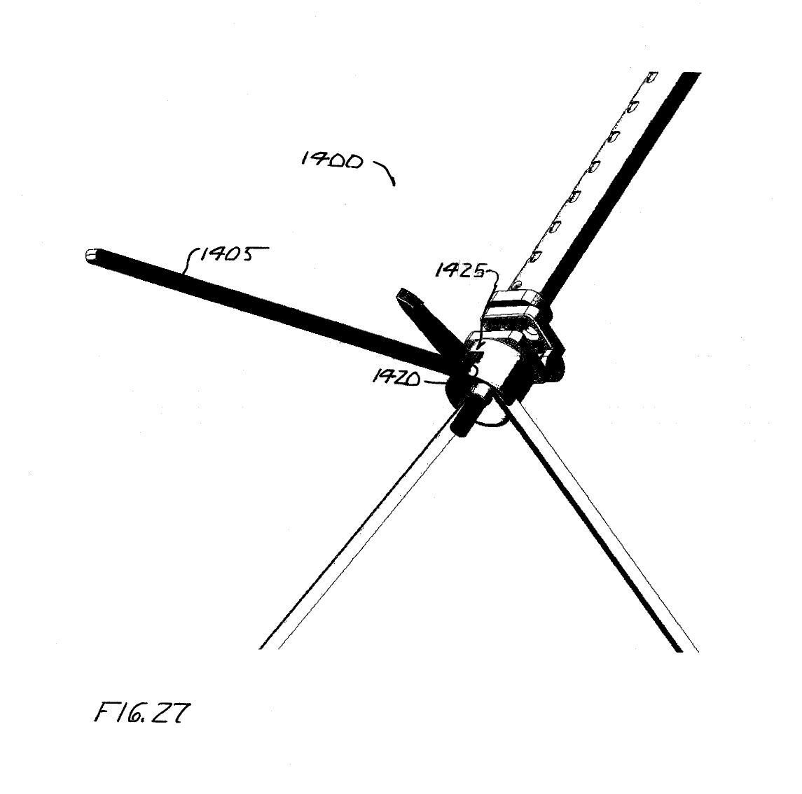

Referring to FIGS. 22 and 23, another embodiment of a music stand 1800 configured according to principles of the invention employs a pedestal 1100 that folds against, rather than being stowed within column 200. In this embodiment, music stand 1800 folds over itself in thirds. Specifically, rack 300 and pedestal 1100 fold alongside or generally parallel to column 200. Hinges 800a, 800b at either end of column 200 work in reverse correlation to the opening and closing of music stand 1800. That is, when music stand 1800 is open, hinges 800a, 800b are closed and vice versa, when music stand 1800 is closed, hinges 800a, 800b are open.

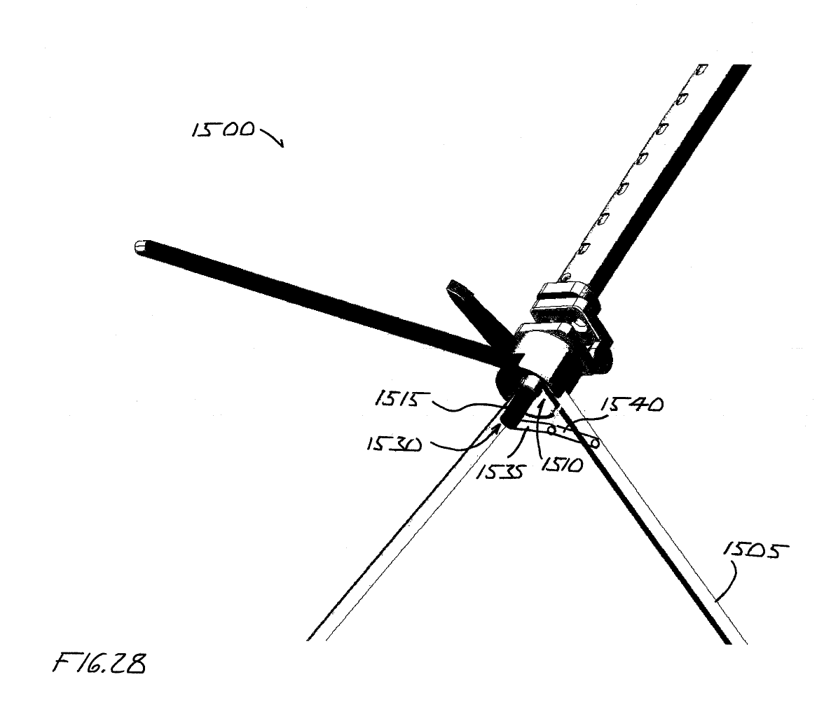

Referring to FIG. 24, pedestal 1100 is similar to pedestal 400, except that instead of base 410, pedestal 1100 employs a base 1110 to which legs 1105 are pivotally mounted. Base 1110 is received and secured in a cup 1115. Cup 1115 may include notches 1120 that are configured and coordinated with base 1110 and legs 1105 to restrain legs 1105 from articulating beyond an open position, as shown in FIG. 22.

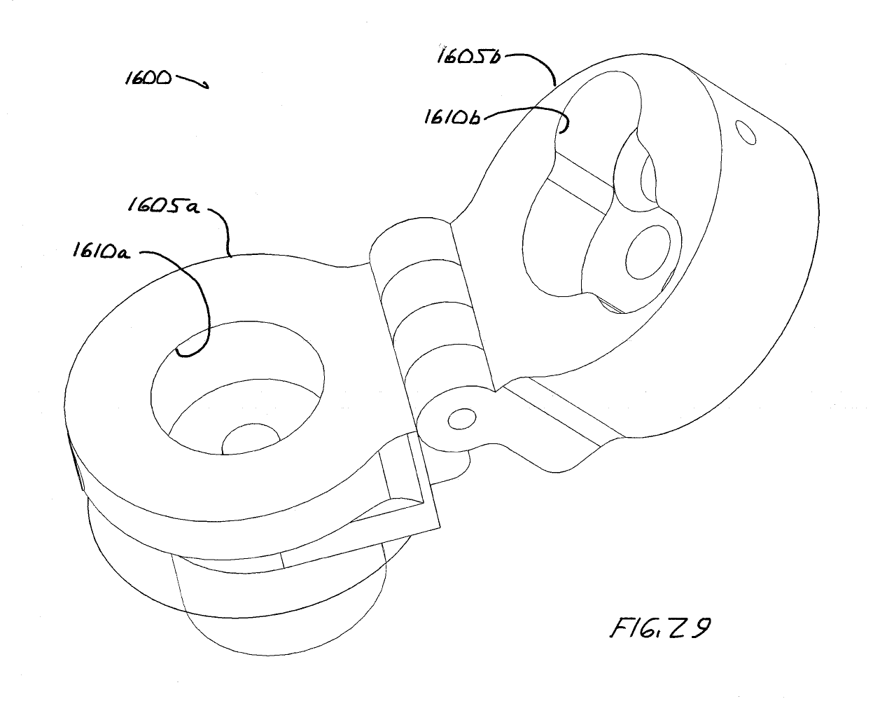

Referring to FIGS. 25 and 26, another embodiment of the invention includes a pedestal 1300 that employs attractive, preferably magnetic principles to maintain legs 1305 pivotally mounted in a closed position as shown. As shown in FIG. 26, base 1310 includes a cylindrical magnet 1315 that is sized, configured and endowed with sufficient attractive properties to maintain legs 1305 against it.

Referring to FIG. 27, yet another embodiment of the invention includes a pedestal 1400 that is comparable to pedestal 1100, but also includes one or more magnets 1425 disposed at the top of each of notches 1420. Magnets 1425 are configured with sufficient attractive force to maintain legs 1405 in an open position, as shown.

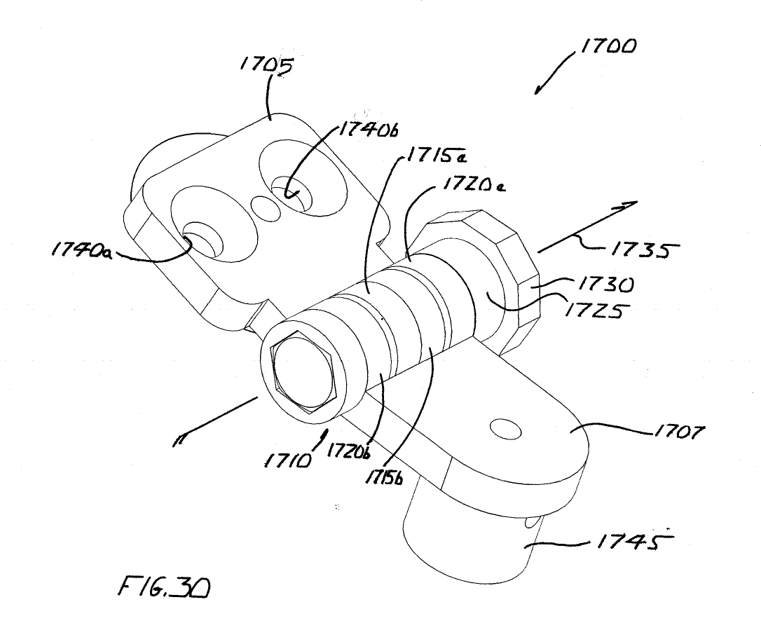

Referring to FIG. 28, yet another embodiment of the invention includes a pedestal 1500 configured so that each of legs 1505 moves generally synchronously with the other of legs 1505. To this end, a disk 1530 is disposed on the end of a member 1515 extending from base 1510. A first link 1535 has one end pivotally connected to disk 1530. A second link 1540 has one end pivotally mounted on leg 1505. Link 1535 and link 1540 are pivotally connected.

The foregoing folding-pedestal embodiments preferably employ another hinge 800 interposed between column 200 and pedestal 1100, 1300, 1400, 1500. As shown in FIG. 24 for pedestal 1100, yet also appropriate for pedestal 1300, 1400 and 1500, cup 1115 is configured to mount on one of wings 805a, 805b. A cap 1200 is configured to mount on the other wing 805a, 805b of hinge 800. Cap 1200 is comparable to cap 1000 in that it is configured to be mounted on lower extension 215, as shown in FIG. 23.

Referring to FIG. 29, another embodiment of the invention employs a magnetically-enhanced hinge 1600 in place of hinge 800 interposed between column 200 and pedestal 400, 1100, 1300, 1400, 1500. The hinged in 1600 includes wings 1605a, 1605b that respectively have recesses 1610a, 1610b. Each of recesses 1610a, 1610b contains mutually attractive elements (not shown), such as a magnet and another magnet, a magnet and magnetically attractive material, or comparable detachable fastening mechanisms, such as hook-and-loop fasteners. In operation, when hinge 1600 defines a closed position, comparable to that shown for hinge 800 in FIG. 22, the mutually attractive elements maintain hinge 1600 in the closed position.

The invention is not limited to the particular embodiments described and depicted herein, rather only to the following claims.

I claim:

1. Music stand comprising:
a column comprising:
a first segment having at least one positional slot; and
a second segment having a protrusion configured to be received in said at least one positional slot;
wherein, when said protrusion is received in said at least one positional slot, said protrusion can prevent relative translation of said first segment and said second segment in at least one direction, thereby defining a unique extension; and
a support, selected from a rack and a pedestal, fixed relative to said column.

2. Music stand of claim 1, wherein said first segment has one or both of:
a detent in communication with said at least one positional slot configured to discourage relative translation of said protrusion; and
a transitional slot in communication with said at least one positional slot;
wherein said protrusion is configured to be received in said transitional slot.

3. Music stand of claim 1, wherein said column is configured to receive said support.

4. Music stand of claim 3, further comprising biasing means for biasing said support relative to said column.

5. Music stand of claim 3, further comprising a lock for selectably maintaining said support relative to said column.

6. Music stand of claim 3, wherein said support is configured to collapse to facilitate reception in said column.

7. Music stand of claim 1, further comprising a hinge interposed between said column and said support;
wherein, when said support is a pedestal, said hinge comprises:
a first wing;
a second wing pivotally mounted on said first wing;
a first element mounted on said first wing; and
a second element mounted on said second wing;
wherein said first element and said second element are mutually attractive and/or selectably connectable.

8. Music stand of claim 7, wherein, when said support is a rack, said hinge comprises:
a first wing extending from a first barrel;
a second wing extending from a second barrel;
wherein:
said first barrel and said second barrel have a common axis; and
compressing said first barrel and said second barrel along said common axis decreases relative rotatability thereof; and
means for controlling compression between said first barrel and said second barrel.

9. Music stand of claim 7, wherein, when said support is a rack, said hinge comprises:
a first wing;
a second wing pivotally mounted on said first wing;
a first element mounted on said first wing; and
a second element mounted on said second wing;
wherein said first element and said second element are mutually attractive and/or selectably connectable.

10. Music stand of claim 9, wherein, when said support is a rack, when said first wing and said second wing define a closed position, said first element and said second element develop attraction sufficient to maintain the closed position.

11. Music stand of claim 7, wherein, when said support is a pedestal, when said first wing and said second wing define a closed position, said first element and said second element develop attraction sufficient to maintain the closed position.

12. Music stand of claim 1, wherein said rack comprises:
a frame that defines a channel; and
an arm pivotally mounted on said frame that is articulable into said channel.

13. Music stand of claim 12, further comprising a link connected to said arm and said frame and that limits articulation of said arm to an open position relative to said frame.

14. Music stand of claim 12, further comprising a second arm pivotally mounted on said frame and that is articulable into said channel and a link connected to said arm and said second arm and that limits articulation of said second arm to an open position relative to said arm.

15. Music stand of claim 14, further comprising:
a shelf pivotally mounted on said frame and that is articulable to a closed position relative thereto; and
a link connected to said shelf and said second arm and that limits articulation of said shelf to an open position relative to said frame.

16. Music stand of claim 12, further comprising a shelf pivotally mounted on said frame and that is articulable to a closed position relative to said frame.

17. Music stand of claim 16, further comprising a link connecting said shelf and said frame and that limits articulation of said shelf to an open position relative to said frame.

18. Music stand of claim 1, wherein said pedestal comprises:
a base; and
at least one leg pivotally mounted on said base.

19. Music stand of claim 18, wherein pivoting one of said at least one leg induces pivoting of another one of said at least one leg.

20. Music stand of claim 18, further comprising a stop mounted on said base;
wherein said stop and one of said at least on leg are mutually attractive and/or selectably connectable.

21. Music stand of claim 20, wherein, when said stop and said one of said at least on leg define an opened position and/or a closed position, said stop and said one of said at least on leg develop attraction sufficient to maintain the opened and/or closed position.

22. Music stand of claim 1, wherein when said support comprises a rack, further comprising a pedestal fixed relative to said column comprising:
a base; and
at least one leg pivotally mounted on said base.

23. Music stand of claim 22, wherein pivoting one of said at least one leg induces pivoting of another one of said at least one leg.

24. Music stand of claim 22, further comprising a stop mounted on said base, wherein said stop and one of said at least on leg are mutually attractive and/or selectably connectable.

25. Music stand of claim 24, wherein, when said stop and said one of said at least on leg define an opened position and/or a closed position, said stop and said one of said at least on leg develop attraction sufficient to maintain the opened position and/or closed position.

26. Pedestal for music stand comprising:
a base;
at least one leg pivotally mounted on said base; and
a stop mounted on said base, wherein said stop and one of said at least on leg are mutually attractive and/or selectably connectable.

27. Pedestal of claim 26, wherein, when said stop and said one of said at least on leg define a opened position and/or a closed position, said stop and said one of said at least on leg develop attraction sufficient to maintain the opened position and/or a closed position.

28. Pedestal of claim 26, wherein pivoting one of said at least one leg induces pivoting of another one of said at least one leg.

29. Rack for music stand comprising:
a frame that defines a channel; and
an arm pivotally mounted on said frame that is articulable into said channel.

30. Rack of claim 29, further comprising a link connected to said arm and said frame and that limits articulation of said arm to an open position relative to said frame.

31. Rack of claim 29, further comprising a second arm pivotally mounted on said frame and that is articulable into said channel and a link connected to said arm and said second arm and that limits articulation of said second arm to an open position relative to said arm.

32. Rack of claim 31, further comprising:
a shelf pivotally mounted on said frame and that is articulable to a closed position relative thereto; and
a link connected to said shelf and said second arm and that limits articulation of said shelf to an open position relative to said frame.

33. Rack of claim 29, further comprising a shelf pivotally mounted on said frame and that is articulable to a closed position relative to said frame.

34. Rack of claim 33, further comprising a link connecting said shelf and said frame and that limits articulation of said shelf to an open position relative to said frame.

35. Hinge comprising:
a first wing;
a second wing pivotally mounted on said first wing;
a first element mounted on said first wing; and
a second element mounted on said second wing;
wherein said first element and said second element are mutually attractive and/or selectably connectable.

36. Hinge of claim 35, wherein, when said first wing and said second wing define a closed position, said first element and said second element develop attraction sufficient to maintain the closed position.
